(19) United States
(12) Patent Application Publication
(10) Pub. No.: US 2023/0306632 A1
(43) Pub. Date: Sep. 28, 2023

(54) IMAGE RECOGNITION BASED INDIVIDUAL IDENTIFICATION AND LOCALIZATION SYSTEM

(71) Applicant: SIGNIFY HOLDING B.V., EINDHOVEN (NL)

(72) Inventors: DONG HAN, NEWTON, MA (US); JIN YU, LEXINGTON, MA (US)

(21) Appl. No.: 18/021,578

(22) PCT Filed: Aug. 2, 2021
(86) PCT No.: PCT/EP2021/071558

§ 371 Date: Feb. 16, 2023

Related U.S. Application Data
(60) Provisional application No. 63/070,659, filed on Aug. 26, 2020.

(30) Foreign Application Priority Data
Sep. 4, 2020 (EP) 20194513.6

(51) Int. Cl. G06T 7/73; G06V 40/16; G06F 3/01

(52) U.S. Cl. CPC G06T 7/73; G06F 3/012; G06V 40/174; G06T 2207/10024; G06T 2207/10028; G06T 2207/10048

(57) ABSTRACT

A system for identifying and determining a location of an individual is disclosed. The system is configured to: (1) identify individuals within a detection area based on a preliminary data set captured by imaging sensors; (2) show a coordination identifier on a display; (3) receive a identifier response signal transmitted by a communication device operated by an individual; (4) generate an identifier time stamp corresponding to receiving the identifier response signal; (5) obtain a imaging data set captured by the imaging sensors; (6) determine a head position pattern of the individuals; (7) identify a subset of the individuals including individuals having a head position pattern meeting a pre-determined head position pattern; (8) designate, if the subset consists of only one individual, the individual of the subset as a recognized individual; (9) determine the location of the recognized individual based on the imaging data set.

### FIELD OF THE DISCLOSURE

The present disclosure is directed generally to using image recognition to identify and locate an individual interfacing with an interactive electronic system, such as a connected lighting system.

### BACKGROUND

Publicly controllable and interactive connected lighting systems are becoming more and more common. For example, individuals proximate to the Empire State Building may soon control an aspect of its connected lighting system via the Spireworks mobile application. However, an individual who controls the Empire State Building lighting may also wish for a temporary acknowledgement of their control. For example, the individual may wish to have a portion of the lighting shine down on them in a spotlight-like beam. This may be particularly desirable if the individual wishes to perform a public action or gesture, such as a wedding proposal. Further, the public area where the individual is standing may be saturated with wireless networks and transmissions, making the transmission of identifying information from the individual to the connected lighting system undesirable from both a connectivity and a privacy perspective. Accordingly, it would be advantageous to identify and locate individuals controlling a connected lighting system without the transmission of identifying information.

### SUMMARY OF THE DISCLOSURE

The present disclosure is directed generally to an interactive electronic system, such as a connected lighting system, configured to identify and locate an individual. The system begins by capturing a preliminary data set of a detection area. The system then identifies one or more individuals from the preliminary data set. The system then displays a coordination identifier on a display. Upon seeing the coordination identifier on a display, one or more of the individuals in the detection area enter the coordination identifier into a mobile application on their communication device. The communication device then transmits an identifier response signal, corresponding to the coordination identifier, to the system. The system generates a time stamp upon receiving the identifier response signal. The system then obtains an imaging data set captured during a period around the time stamp. The system then analyzes the imaging data set to identify a subset of individuals moving their head according to a pre-determined pattern wherein an individual first looks up at the display to read the coordination identifier, then looks down at their device to enter an input corresponding to the identifier, and then looks up at the display again for a response from the system or a second coordination identifier. If this identified subset includes only one individual, the individual is designated as a recognized individual, and the location of the recognized individual is determined. If the identified subset includes more than one individual, the display shows a second coordination identifier, and the process repeats until the subset includes only one individual.

Generally, in one aspect, a system for identifying and determining a location of an individual is disclosed. The system may include a controller. The controller may be communicatively coupled to a display. The display may be one of a projection screen, LED screen, television, or plurality of light bulbs.

The controller may also be communicatively coupled to one or more imaging sensors. Each imaging sensor may have a field of view. The imaging sensors may include one or more digital cameras. The imaging sensors may further include one or more infrared (IR) cameras or RGB-Depth (RGBD) cameras. The IR cameras or RGBD cameras may be arranged on or in one or more luminaires.

The controller may be configured to identify one or more individuals within a detection area based on a preliminary data set. The preliminary data set may be captured by the imaging sensors. The detection area may correspond to the fields of view of the one or more imaging sensors. According to an example, the controller may be configured to identify the one or more individuals based on a Head Position Estimation (HPE) algorithm.

The controller may be further configured to transmit a first coordination signal to the display. The display may be configured to show a first coordination identifier. The first coordination identifier may be based on the first coordination signal. According to an example, the first coordination identifier may include at least one of a number, symbol, letter, word, and/or color.

The controller may be further configured to receive a first identifier response signal. The first identifier response signal may be transmitted by one of one or more communication devices operated by one of the one or more individuals. According to an example, one of the one or more communication devices may be a smartphone, smartwatch, tablet, or remote controller.

The controller may be further configured to generate a first identifier time stamp. The first identifier time stamp may correspond to the controller receiving the first identifier response signal.

The controller may be further configured to obtain a first imaging data set. The first imaging data set may be captured by the one or more imaging sensors from a first pre-time stamp time to a first post-time stamp time.

The controller may be further configured to determine a first head position pattern of the one or more individuals from the first pre-time stamp time to the first post-time stamp time. The first head position pattern may be determined based on the first imaging data set.

The controller may be further configured to identify a first subset of the one or more individuals. The first subset may include individuals having a first head position pattern meeting a pre-determined head position pattern.

The controller may be further configured to designate, if the first subset consists of only one individual, the individual of the first subset as a recognized individual. The controller may be further configured to determine the location of the recognized individual. The location of the recognized individual may be determined based on the first imaging data set.

According to an example, the controller may be further configured to transmit a second coordination signal to the display. The display may be configured to show a second coordination identifier based on the second coordination signal.

The controller may be further configured to receive a second identifier response signal. The second identifier response signal may be transmitted by one of the one or more communication devices. The one or more communication devices may be operated by one of the one or more individuals.

The controller may be further configured to generate a second identifier time stamp. The second identifier time stamp may correspond to the controller receiving the second identifier response signal.

The controller may be further configured to obtain a second imaging data set. The second imaging data set may be captured by the one or more imaging sensors during a second pre-time stamp interval and a second post-time stamp interval.

The controller may be further configured to determine a second head position pattern of the individuals of the first subset from a second pre-time stamp time and a second post-time stamp time. The second head position pattern may be determined based on the second imaging data set.

The controller may be further configured to identify a second subset of the individuals. The second subset may include individuals of the first subset having a second head position pattern meeting the pre-determined head position pattern.

The controller may be further configured to designate, if the second subset consists of only one individual, the individual of the second subset as the recognized individual.

The controller may be further configured to determine the location of the recognized individual. The location may be determined based on the second imaging data set.

According to an example, the controller may be further configured to determine a first facial expression for the one or more individuals from the first identifier time stamp to the first post-time stamp time. The first facial expression may be determined based on the first imaging data set. Further, the first subset may be further limited to individuals having a first facial expression meeting a pre-determined facial expression pattern.

According to an example, the system may further include one or more luminaires configured to illuminate the location of the recognized individual.

According to an example, one of the one or more communication devices may transmit the identifier response signal upon receiving a user input corresponding to the coordination identifier.

According to another aspect, a method for identifying and determining a location of an individual is provided. The method may include identifying one or more individuals within a detection area. The individuals may be identified based on a preliminary data set. The preliminary data set may be captured by one or more imaging sensors. The detection areas may correspond to fields of view of the one or more imaging sensors.

The method may further include showing a first coordination identifier. The first coordination identifier may be shown via a display.

The method may further include receiving a first identifier response signal. The first identifier response signal may be received by a controller. The first identifier response signal may be transmitted by one of one or more communication devices. The one or more communication devices may be operated by one of the one or more individuals.

The method may further include generating a first identifier time stamp. The first identifier time stamp may correspond to the controller receiving the first identifier response signal.

The method may further include obtaining a first imaging data set. The first imaging data set may be captured by the one or more imaging sensors.

The method may further include determining a first head position pattern of the one or more individuals from a first pre-time stamp time to a first post-time stamp time. The first head position pattern may be determined based on the first imaging data set.

The method may further include identifying a first subset of the one or more individuals. The one or more individuals of the first subset may have a first head position pattern meeting a pre-determined head position pattern.

The method may further include designating, if the first subset consists of only one individual, the individual of the first subset as a recognized individual.

The method may further include determining the location of the recognized individual. The location may be determined based on the first imaging data set.

According to an example, the method may further include showing a second coordination identifier. The second coordination identifier may be shown via the display. The method may further include receiving, via the controller, a second identifier response signal transmitted by one of the one or more communication devices operated by one of the one or more individuals.

The method may further include generating a second identifier time stamp. The second identifier time stamp may correspond to the controller receiving the second identifier response signal.

The method may further include obtaining a second imaging data set. The second imaging data set may be captured by the one or more imaging sensors.

The method may further include determining a second head position pattern of the individuals of the first subset from a second pre-time stamp time to a second post-time stamp time. The second head position pattern may be determined based on the second imaging data set.

The method may further include identifying a second subset of the individuals. The second subset may include the individuals of the first subset having a second head position pattern meeting the pre-determined head position pattern.

The method may further include designating, if the second subset consists of only one individual, the individual of the second subset as the recognized individual.

The method may further include determining the location of the recognized individual. The location may be determined based on the second imaging data set.

The method may further include transmitting, via one of the one or more communication devices, the identifier response signal upon receiving a user input corresponding to the coordination identifier.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic of a system for identifying and determining a location of an individual, in accordance with an example.

FIG. 2 is a further schematic of a system for identifying and determining a location of an individual, wherein the individual is identified and located upon running a first iteration of the system, in accordance with an example.

FIG. 3 is a further schematic of a system for identifying and determining a location of an individual, wherein the individual is unable to be identified and located upon running a first iteration of the system, in accordance with an example.

FIG. 4 is a schematic of a system for identifying and determining a location of an individual, wherein the individual is identified and located upon running a second iteration of the system, in accordance with an example.

FIG. 5 is a further schematic of a system for identifying and determining a location of an individual, wherein the individual is identified and located upon running a second iteration of the system, in accordance with an example.

FIG. 6 is a flowchart of a method for identifying and determining a location of an individual, in accordance with an example.

FIG. 7 is a further flowchart of a method for identifying and determining a location of an individual, in accordance with an example.

### DETAILED DESCRIPTION OF EMBODIMENTS

The present disclosure is directed generally to an interactive electronic system, such as a connected lighting system configured to identify and locate an individual, typically an individual remotely controlling the interactive connected lighting system in a public area. In further examples, the interactive system may be a musical fountain, advertising board, speaker system, or any other system of which it would be advantageous to identify and locate an individual controlling the system. The system begins by capturing a preliminary data set of a detection area using a combination of digital cameras, infrared (IR) cameras, and RGB-Depth (RGBD) cameras. The system then identifies one or more individuals from the preliminary data set using a Head Pose Estimation (HPE) algorithm. The system then displays a coordination identifier, such as a number or symbol, on a display, such as a projection screen or LCD screen. Upon seeing the coordination identifier on a display, one or more of the individuals in the detection area enters the coordination identifier into a mobile application on their communication device, such as a smartphone. The communication device then transmits an identifier response signal, corresponding to the coordination identifier, to the system. The system generates a time stamp upon receiving the identifier response signal. The system then obtains an imaging data set captured during a period around the time stamp (i.e., from a time before the time stamp to a time after the time stamp). The system then analyzes the imaging data set to identify a subset of individuals moving their head according to a pre-determined pattern wherein an individual first looks up at the display to read the coordination identifier, then looks down at their device to enter an input corresponding to the identifier, and then looks up at the display again for a response from the system or a second coordination identifier. If this identified subset includes only one individual, the individual is designated as a recognized individual, and the location of the recognized individual is determined. If the identified subset includes more than one individual, the display shows a second coordination identifier, and the process repeats until the subset includes only one individual. The system may further analyze the imaging data set to identify individuals who make a pre-determined facial pattern after the time stamp, such as smiling, and then further limit the subset to those individuals.

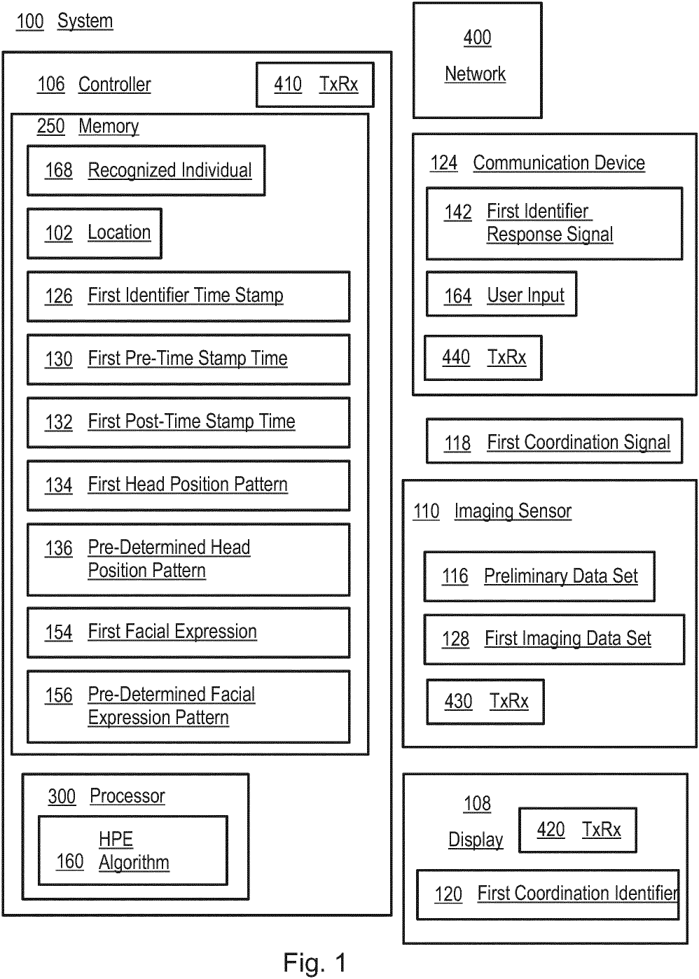

Generally, in one aspect, and with reference to FIGS. 1-5, a system 100 for identifying and determining a location 102 of an individual 104 is disclosed. Broadly, the system may include a controller 106, one or more communication devices 124, one or more imaging sensors 110, and a display 108 capable of communication via wired or wireless network 400.

With reference to FIG. 1, the controller 106 may include a memory 250, a processor 300, and a transceiver 410. The memory 250 and processor 300 may be communicatively coupled via a bus to facilitate processing of data stored in memory 300. Transceiver 410 may be used to receive data from the one or more imaging sensors 110 via the network 400. The data received by the transceiver 410 may be stored in memory 250 and/or processed by processor 300. In an example, the transceiver 410 may facilitate a wireless connection between the controller 106 and the network 400.

The network 400 may be configured to facilitate communication between the controller 106, the one or more imaging sensors 110, the display 108, the one or more communication devices 124, and/or any combination thereof. The network 400 may be a wired and/or wireless network following communication protocols such as cellular network (5G, LTE, etc.), Bluetooth, Wi-Fi, Zigbee, and/or other appropriate communication protocols. In an example, the imaging sensor 110 may wirelessly transmit, via the network 400, a preliminary data set 212, a first imaging data set 128, and/or a second imaging data set 172 to the controller 106 for storage in memory 250 and/or processing by the processor 300.

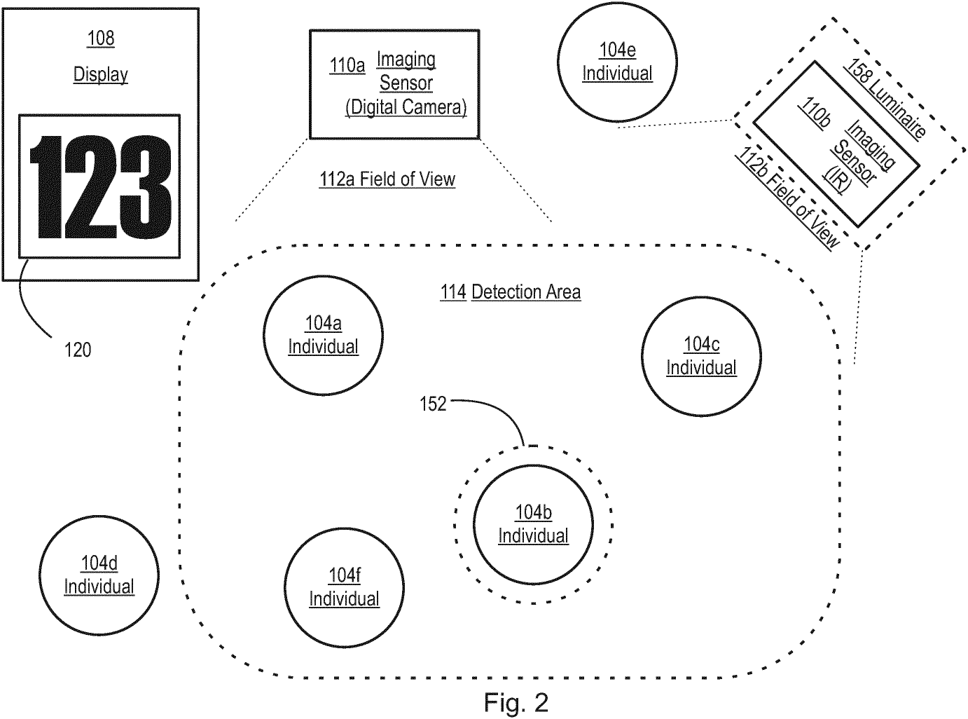

The controller 106 may be communicatively coupled to a display 108. The display 108 may be one of a projection screen, LED screen, television, or plurality of light bulbs. The display 108 may be of any type capable of showing a number, symbol, letter, word, color, or any combination of one or more of the foregoing. For example, and as shown in FIGS. 2, 4, and 5 the display 108 may include an LED screen configured to show the numbers 000 to 999.

The controller 106 may also be communicatively coupled to one or more imaging sensors 110. With reference to FIGS. 2, 3, and 5, each imaging sensor 110 may have a field of view 112. In FIGS. 2, 3, and 5, imaging sensor 110a has a field of view 112a, and imaging sensor 110b has a field of view 112b. The imaging sensors 110 may be configured to continuously monitor a crowd of individuals 104 within detection area 114.

In a preferred example, the imaging sensors 110 may include one or more digital cameras. The digital cameras may be high-resolution image or video cameras. The digital camera may be capable of capturing images and/or video in a variety of color modes. The digital cameras may capture data at a high resolution. Imaging sensor 110a in FIGS. 2, 3, and 5 is shown as including a digital camera.

The imaging sensors 110 may further include one or more infrared (IR) cameras. The IR cameras are configured to detect infrared energy, such as heat. The IR cameras may capture data at a high resolution. Imaging sensor 110b in FIGS. 2, 3, and 5 is shown as including an IR camera.

The imaging sensors 110 may further include one or more RGBD cameras. RGBD cameras are configured to detect red, green, and blue (RGB) colors in the fields of view of the camera, and combine the RGB color information with depth information. The RGBD cameras may capture data at a high resolution.

In a further example, the IR cameras or RGBD cameras may be arranged on or in one or more luminaires 158. FIGS. 2, 3, and 5 show IR camera 110b arranged inside luminaire 158. Depending on the application, the system 100 may include hundreds of luminaires 158 with varying embedded imaging sensors 110 and/or other components. In a further example, one or more digital cameras may be embedded in the one or more luminaires 158.

The controller 106 may be configured to identify one or more individuals 104 within a detection area 114 based on a preliminary data set 116. The preliminary data set 116 may be captured by at least one of the imaging sensors 110 while continuously monitoring the detection area 114 prior to identifying or locating an individual 104. The preliminary data set 116 may be a combination or blend of data from multiple imaging sensors 110. The detection area 114 may correspond to the fields of view 112 of the one or more imaging sensors 110. In a preferred example, the data from multiple imaging sensors 110 will consist of either entirely video data or entirely still image data. Combining video data with still image data may lead to processing issues and/or inefficiencies due to certain algorithms requiring video data consisting of a video stream or a series of continuous images, rather than images captured seconds apart.

As shown in FIGS. 2, 3, and 5, detection area 114 is defined by fields of view 112a and 112b which correspond to digital camera 110a and IR camera 110b. Individuals 104a, 104b, 104c, and 104f are within the detection area 114, and are therefore monitored by the digital camera 110a and/or IR camera 110b. Individuals 104d and 104e are outside of the detection area 114, and are therefore not monitored by the system 100. An operator of the system 100 may alter the detection area 114 by adjusting the fields of view 112a, 112b or placement of sensors 110a, 110b. In one example, the sensors 110 may be continually monitoring the detection area 114, and the preliminary data set 116 may include data captured during a set time period (such as 10 seconds or 2 minutes) prior to the display of the first coordination identifier 120 on the display 108.

According to an example, the controller 106 may be configured to identify the one or more individuals 104 based on a HPE algorithm 160. The processor 300 may identify the individuals through an HPE algorithm 160 analysis of the preliminary data set 116.

The imaging sensors 110 may transmit the one or more portions of preliminary data set 116 to controller 106 via the wired and/or wireless network 400. In one example, the imaging sensors 110 transmit the preliminary data set 116 wirelessly via transceiver 430, and the controller wirelessly receives the preliminary data set via transceiver 410.

The controller 106 may be further configured to transmit a first coordination signal 118 to the display 108. The first coordination signal 118 may be transmitted via the wired and/or wireless network 400. In one example, the controller 106 wirelessly transmits the first coordination signal 118 via transceiver 410, and the display 108 wirelessly receives the first coordination signal 118 via transceiver 420.

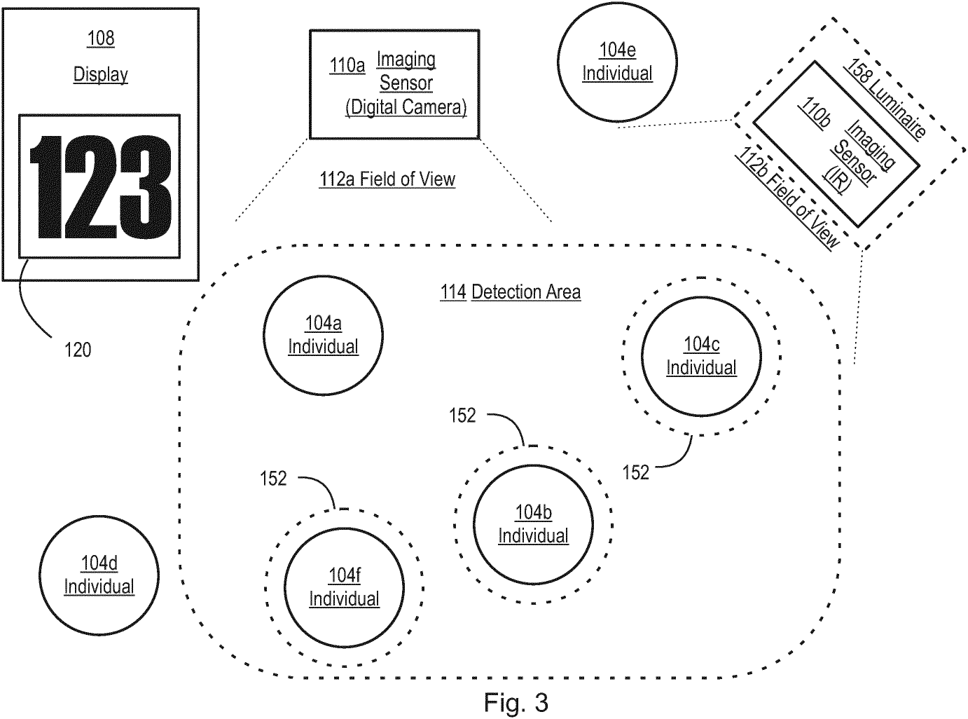

The display 108 may be configured to show a first coordination identifier 120. The first coordination identifier 120 may be based on the first coordination signal 118 received by the display 108. According to an example, the first coordination identifier 120 may include at least one of a number, symbol, letter, word, and/or color. As shown in FIGS. 2 and 3, the first coordination identifier 120 includes the number “123”.

The controller 106 may be further configured to receive a first identifier response signal 142. The first identifier response signal 142 may be transmitted by one of one or more communication devices 124 operated by one of the one or more individuals 104. According to an example, one of the one or more communication devices 104 may be a smartphone, smartwatch, tablet, or remote controller running a mobile application corresponding to the system 100. According to a further example, one of the one or more communication devices 124 may transmit the first identifier response signal 142 upon receiving a user input 164 corresponding to the first coordination identifier 120. The first identifier response signal 142 may be transmitted wirelessly by the communication device 124 via transceiver 440. In the example illustrated by FIGS. 2 and 3, the first identifier response signal 142 may be transmitted when one of the individuals 104 enters a user input 164 corresponding to the number “123” shown on the display 108 into an interface of a mobile application. For example, the user input 164 may be a keypad entry of “1″-“2”-“3” via a virtual keypad of a smartphone. The user input 164 may be any other input which conveys to the system 100 that one of the individuals 104 has seen the first coordination identifier 120 shown on the display 108, and wishes to be recognized.

The controller 106 may be further configured to generate a first identifier time stamp 126. The first identifier time stamp 126 may correspond to the controller 106 receiving the first identifier response signal 142. In a preferred example, the controller 106 calibrates the first identifier time stamp 126 to match the moment the individual 104 enters the user input 164, into their communication device 124, corresponding to the first coordination identifier 120 shown on the display 108. In other words, and with reference to FIGS. 2 and 3, the first identifier time stamp 126 should match the moment the individual 104 enters “123” into their smartphone. The first identifier time stamp 126 marks the point in time about which the system 100 should analyze the head positions of the individuals to determine which of them entered “123” into their smartphone. Accordingly, the system 100 should analyze the head positions of the individuals at some point in time prior to the first identifier time stamp 126 to observe individuals 104 who had their heads raised watching the display 108. The system should continue the analysis to observe individuals 104 who bring their head down to enter “123” into their smartphone, and then raise their head again to continue watching display 108 after the first identifier time stamp 126.

The controller 106 may be further configured to obtain a first imaging data set 128. The first imaging data set 128 may be captured by the one or more imaging sensors 110 from a first pre-time stamp time 130 to a first post-time stamp time 132. In one example, the first imaging data set 128 may only include data captured from a single imaging sensor 110, such as a digital camera 110a. In a further example, the first imaging data set 128 may be a combination of the data collected by multiple imaging sensors 110, such as the digital camera 110a and IR camera 110b of FIGS. 2 and 3. In this example, the digital camera 110a may act as the primary data source of the first imaging data set 128, supplemented by the IR camera 110b. In further examples, the IR camera 110b or a RGBD camera may act as the primary data source.

In an even further example, the first pre-time stamp time 130 may be 30 seconds prior to the first identifier time stamp 126. Further, the first post-time stamp time 132 may be 30 seconds after the first identifier time stamp 126. The intervals of time between the first identifier time stamp, the first pre-time stamp time 132, and the first post-time stamp time 134 may depend on a variety of factors, including the processing power of processor 300 and the size of memory 250. While shorter time intervals may miss important head movements required to identify the individual 104 whose communication device 124 transmitted the first identifier response signal 142, excessively long time intervals may slow down the system 100 by processing unnecessary data. In some applications, the interval between the first pre-time stamp time 130 and the first identifier time stamp 126 may be longer than the interval between the first identifier time stamp 126 and the first post-time stamp interval 132, or vice-versa.

The controller 106 may be further configured to determine a first head position pattern 134 of the one or more individuals 104 from the first pre-time stamp time 130 to the first post-time stamp time 132. By analyzing the head positions of the individuals 104, the system 100 can identify and locate individuals 104 without the transmission of identifying information over a network, thereby reducing the amount of local area network traffic and lowering the risk of data breaches.

The first head position pattern 134 may be determined based on the first imaging data set 128. Continuing the example above, processor 300 may process the data of the first imaging data set 128 captured from 30 seconds before the first identifier time stamp 126, to 30 seconds after the first identifier time stamp 126. Accordingly, the first head position pattern 134 for each individual 104 represents the head movement of that individual 104 for a 60 second period about the first identifier time stamp 126. The processer 300 may determine a first head position pattern 134 for each individual 104 in the detection area 114 identified by the HPE algorithm 160. Accordingly, in the example illustrated in FIGS. 2 and 3, the processor 300 determines the first head position pattern 134 of individuals 104a, 104b, 104c, and 104f.

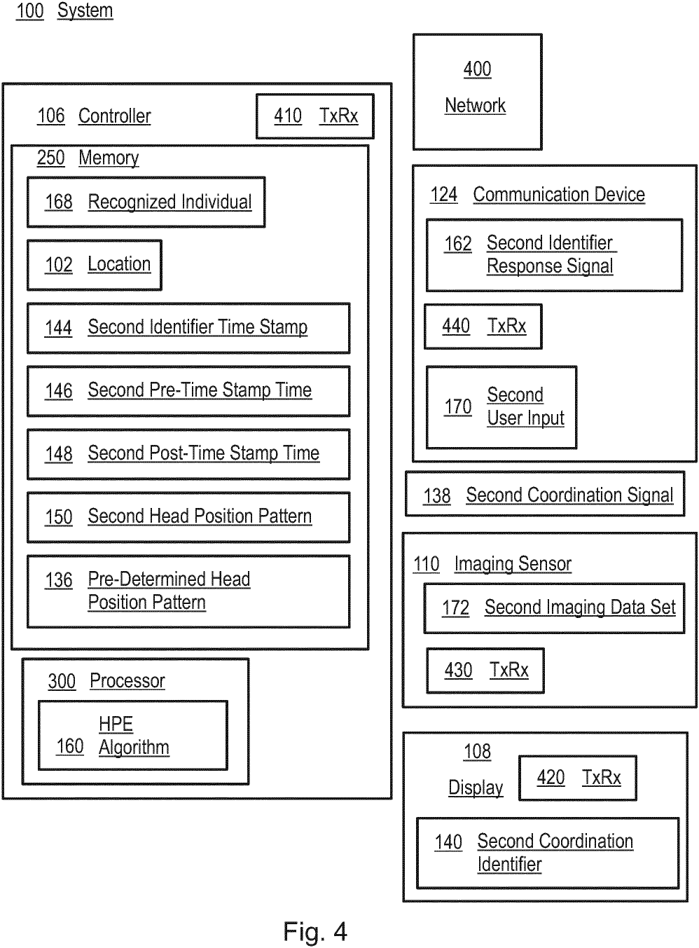

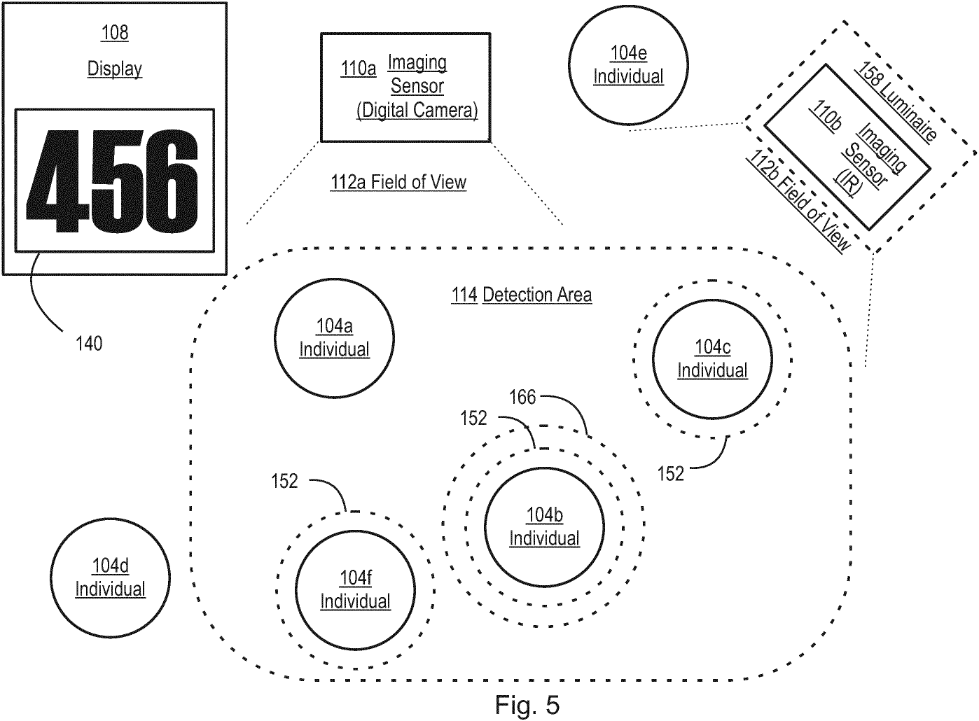

The controller 106 may be further configured to identify a first subset 152 of the one or more individuals 104. The first subset 152 may include individuals 104 having a first head position pattern 134 meeting a pre-determined head position pattern 156. The pre-determined head position pattern 156 defines the head movement the system 100 looks for to find the individual 104 who entered a user input 164 into their communication device 124 at the first identifier time stamp 126. For example, the pre-determined head position pattern 156 may be a 3-stage pattern wherein an individual 104 first (1) looks up at the display 108 to wait for a first coordination identifier 120 to be shown, then (2) looks down at their communication device 124 to enter a user input 164 corresponding to the identifier 120, and then (3) looks back up at the display 108 to wait for feedback or the showing of a second coordination identifier 140 (as shown in FIGS. 4 and 5). In this example, the pre-determined head position pattern 156 may include the individual 104 looking down at the time of the first identifier time stamp 126. The pre-determined head position pattern 156 may include an array of different patterns defining a range of head movement over time. Other pre-determined head position patterns 156 may be utilized depending on the circumstances.

The processor 300 may assign one or more of the individuals 104 to the first subset 152 if their first head position pattern 134 meets the pre-determined head position pattern 136, or if their first head position pattern 134 is within a pre-defined deviation window. The pre-defined deviation window may be calibrated to determine how close the first head position pattern 134 must be to the pre-determined head position pattern 136 for the individual 104 to be grouped into the first subset 152. If the pre-defined deviation window is too narrow, the system may overlook individuals 104 wishing to be recognized due to head movements varying slightly from the pre-determined head position pattern 136. Conversely, an overly broad pre-defined deviation window may lead to a number of false positives in the first subset 152, requiring a high number of iterations to properly recognize the individual 104 who actually transmitted the first identifier response signal 142 and subsequent identifier response signals. For example, FIG. 2 shows an example where the system 100 has assigned a single individual 104b to the first subset 152. FIG. 3 shows a further example where the system has assigned three individuals 104b, 104c, 104f to the first subset 152.

The controller 106 may be further configured to designate, if the first subset 152 consists of only one individual 104, the individual 104 of the first subset 152 as a recognized individual 168. Under proper operating conditions, the recognized individual 168 is the one of the plurality of individuals 104 who entered a user input 164 into their communication device 124 corresponding to the first coordination identifier 120 at the first identifier time stamp 126. The recognized individual 168 may also be controlling other aspects of the system 100 through a user interface of their communication device 124, such as by programming the features and behavior of the luminaires 158.

Once the recognized individual 168 has been determined, the controller 106 may be further configured to determine the location 102 of the recognized individual 168. The location 102 of the recognized individual 168 may be determined based on the first imaging data set 128. According to an example, the system 101 may further include one or more luminaires 158 configured to illuminate the location 102 of the recognized individual 168.

If the first subset 152 does not include any individuals 104, the display 108 may again show the first coordination identifier 120 and the system 100 may repeat the same processing steps as described above. Alternatively, the display 108 may show a different coordination identifier of the same or different type as the first coordination identifier 120.

If, as shown in FIG. 3, the first subset 152 contains more than one individual 104, the system 100 may undergo a second iteration of the processing steps described above to identify a recognized individual 168. In the example described below, the system 100 identifies the recognized individual 168 by focusing on the individuals 104 of the first subset 152, rather than all of the individuals 104 in the detection area 114.

According to an example, and with reference to FIG. 4, the controller 106 may be further configured to transmit a second coordination signal 138 to the display 108. The display 108 may be configured to show a second coordination identifier 140 based on the second coordination signal 138. As shown in FIG. 5, the second coordination identifier 140 includes the number “456”.

The controller 106 may be further configured to receive a second identifier response signal 162. The second identifier response signal 162 may be transmitted by one of the one or more communication devices 124. The one or more communication devices 124 may be operated by one of the one or more individuals of the first subset 152.

The controller 106 may be further configured to generate a second identifier time stamp 144. The second identifier time stamp 144 may correspond to the controller 106 receiving the second identifier response signal 162. Similar to the first identifier time stamp 126, in a preferred example, the controller 106 calibrates the second identifier time stamp 144 to match the moment the individual 104 of the first subset 152 enters a second user input 170 into their communication device 124 corresponding to the second coordination identifier 140 shown on the display 108. In other words, and with reference to FIG. 5, the second identifier time stamp 144 should match the moment the individual 104 of the first subset enters “456” into their smartphone.

The controller 106 may be further configured to obtain a second imaging data set 172. Similar to the first imaging data set 128, the second imaging data set 172 may be captured by the one or more imaging sensors 110 from a second pre-time stamp time 146 to a second post-time stamp time 148.

The controller 106 may be further configured to determine a second head position pattern 150 of the individuals 104 of the first subset 152 from the second pre-time stamp time 146 to the second post-time stamp time 148. The second head position pattern 150 may be determined based on the second imaging data set 172. In the example illustrated in FIG. 5, the processor 300 determines the second head position pattern 150 of individuals 104b, 104c, and 104f.

The controller 106 may be further configured to identify a second subset 166 of the individuals 104. The second subset 166 may include individuals 104 of the first subset 152 having a second head position pattern 150 meeting the pre-determined head position pattern 136. As shown in FIG. 5, individual 104b of the first subset 152 has been identified as the sole member of the second subset.

The controller 106 may be further configured to designate, if the second subset 166 consists of only one individual 104, the individual 104 of the second subset 166 as the recognized individual 168. According to the example shown in FIG. 5, individual 104b is identified as the recognized individual 168. The controller 106 may be further configured to determine the location 102 of the recognized individual 168. The location 102 may be determined based on the second imaging data set 172. If the second subset 166 consists of multiple individuals 104, the system 100 may run additional iterations of the processing described above to further narrow the number of individuals 104 until determining a subset with only one individual 104.

According to an example, the controller 106 may be further configured to determine a first facial expression 154 for the one or more individuals 104 from the first identifier time stamp 126 to the first post-time stamp time 132. The first facial expression 154 may be determined based on the first imaging data set 128. Further, the first subset 152 may be further limited to individuals 104 having a first facial expression 154 meeting a pre-determined facial expression pattern 156. In a further example, the pre-determined facial expression pattern 156 may be a smile. Accordingly, this example further limits the first subset 152 to individuals 104 who smile after a user input 164 corresponding to the first coordination identifier 120 has been entered into one of the communication devices 124 of the system 100. This feature anticipates a user may express happiness or satisfaction at successfully entering in the correct user input 164, especially if their recognition results in the luminaires 158 of the system 100 illuminating their location. Other types of facial expressions may also be used where applicable.

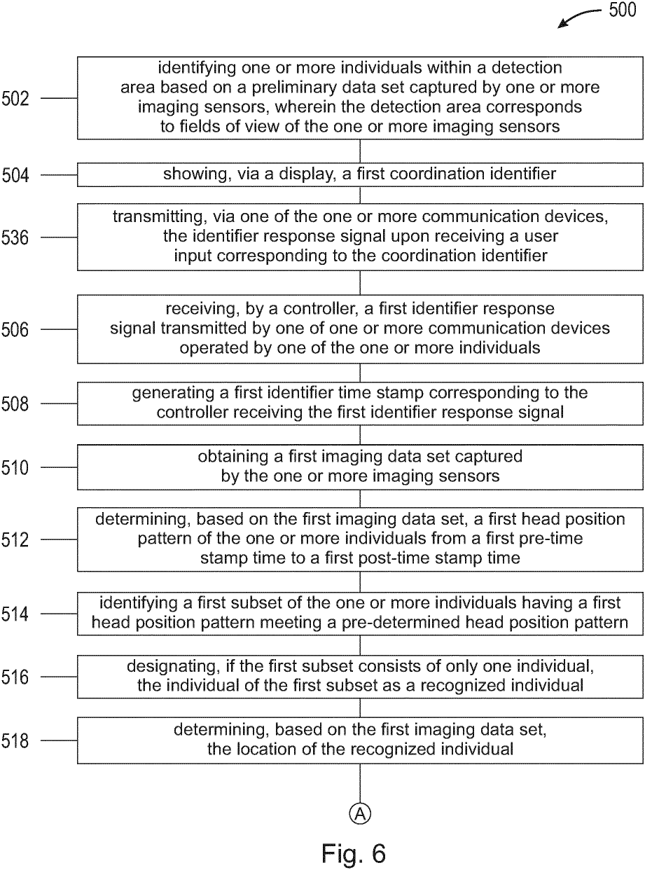

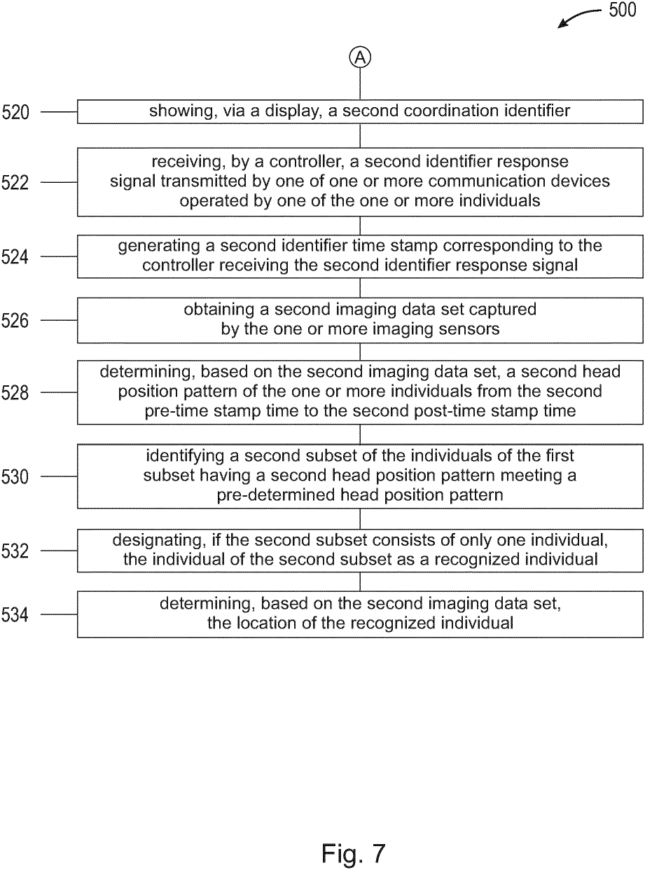

According to another example, and with reference to FIGS. 6 and 7, a method 500 for identifying and determining a location of an individual is provided. The method 500 may include identifying 502 one or more individuals within a detection area. The individuals may be identified based on a preliminary data set. The preliminary data set may be captured by one or more imaging sensors. The detection areas may correspond to fields of view of the one or more imaging sensors.

The method 500 may further include showing 504 a first coordination identifier. The first coordination identifier may be shown via a display.

The method 500 may further include receiving 506 a first identifier response signal. The first identifier response signal may be received by a controller. The first identifier response signal may be transmitted by one of one or more communication devices. The one or more communication devices may be operated by one of the one or more individuals.

The method 500 may further include generating 508 a first identifier time stamp. The first identifier time stamp may correspond to the controller receiving the first identifier response signal.

The method 500 may further include obtaining 510 a first imaging data set. The first imaging data set may be captured by the one or more imaging sensors.

The method 500 may further include determining 512 a first head position pattern of the one or more individuals from a first pre-time stamp time to a first post-time stamp time. The first head position pattern may be determined based on the first imaging data set.

The method 500 may further include identifying 514 a first subset of the one or more individuals. The one or more individuals may have a first head position pattern meeting a pre-determined head position pattern.

The method 500 may further include designating 516, if the first subset consists of only one individual, the individual of the first subset as a recognized individual.

The method 500 may further include determining 518 the location of the recognized individual. The location may be determined based on the first imaging data set.

According to an example, the method 500 may further include showing 520 a second coordination identifier. The second coordination identifier may be shown via the display.

The method 500 may further include receiving 522, via the controller, a second identifier response signal transmitted by one of the one or more communication devices operated by one of the one or more individuals.

The method 500 may further include generating 524 a second identifier time stamp. The second identifier time stamp may correspond to the controller receiving the second identifier response signal.

The method 500 may further include obtaining 526 a second imaging data set. The second imaging data set may be captured by the one or more imaging sensors.

The method 500 may further include determining 528 a second head position pattern of the individuals of the first subset from a second pre-time stamp time to the second post-time stamp time. The second head position pattern may be determined based on the second imaging data set.

The method 500 may further include identifying 530 a second subset of the individuals. The second subset may include the individuals of the first subset having a second head position pattern meeting the pre-determined head position pattern.

The method 500 may further include designating 532, if the second subset consists of only one individual, the individual of the second subset as the recognized individual.

The method 500 may further include determining 534 the location of the recognized individual. The location may be determined based on the second imaging data set.

The method 500 may further include transmitting 536, via one of the one or more communication devices, the identifier response signal upon receiving a user input corresponding to the coordination identifier.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A system for identifying and determining a location of an individual, comprising a controller communicatively coupled to a display and one or more imaging sensors, wherein each imaging sensor has a field of view, and wherein the controller is configured to:
identify one or more individuals within a detection area based on a preliminary data set captured by the one or more imaging sensors, wherein the detection area corresponds to the fields of view of the one or more imaging sensors;
transmit a first coordination signal to the display, wherein the display is configured to show a first coordination identifier based on the first coordination signal;
receive a first identifier response signal transmitted by one of one or more communication devices operated by one of the one or more individuals;
generate a first identifier time stamp corresponding to the control receiving the first identifier response signal;
obtain a first imaging data set captured by the one or more imaging sensors from a first pre-time stamp time to a first post-time stamp time;
determine, based on the first imaging data set, a first head position pattern of each the one or more individuals from the first pre-time stamp time to the first post-time stamp time;
identify a first subset of the one or more individuals having a first head position pattern meeting a pre-determined head position pattern;
designate, if the first subset consists of only one individual, the individual of the first subset as a recognized individual; and
determine, based on the first imaging data set, the location of the recognized individual.

2. The system of claim 1, wherein the controller is further configured to:
transmit a second coordination signal to the display, wherein the display is configured to show a second coordination identifier based on the second coordination signal;
receive a second identifier response signal transmitted by one of the one or more communication devices operated by one of the one or more individuals;
generate a second identifier time stamp corresponding to the controller receiving the second identifier response signal;
obtain a second imaging data set captured by the one or more imaging sensors from a second pre-time stamp time to a second post-time stamp time;
determine, based on the second imaging data set, a second head position pattern of the individuals of the first subset from the second pre-time stamp time to the second post-time stamp time;
identify a second subset of the individuals of the first subset having a second head position pattern meeting the pre-determined head position pattern;
designate, if the second subset consists of only one individual, the individual of the second subset as the recognized individual; and
determine, based on the second imaging data set, the location of the recognized individual.

3. The system of claim 1, wherein the control is further configured to determine, based on the first imaging data set a first facial expression for the one or more individuals from the first identifier time stamp to the first post-time stamp time.

4. The system of claim 3, wherein the wherein the first subset is further limited to individuals having a first facial expression meeting a pre-determined facial expression pattern.

5. The system of claim 1, further comprising one or more luminaires configured to illuminate the location of the recognized individual.

6. The system claim 1, wherein the imaging sensors comprise one or more digital cameras.

7. The system of claim 6, wherein the imaging sensors further comprise one or more infrared (IR) cameras or RGB-Depth (RGBD) cameras arranged on or in one or more luminaires.

8. The system of claim 1, wherein the display is one of a projection screen, LED screen, television, or plurality of light bulbs.

9. The system of claim 1, wherein the first coordination identifier comprises at least one of a number, symbol, letter, word, and/or color.

10. The system of claim 1, wherein the controller is configured to identify the one or more individuals based on a Head Position Estimation (HPE) algorithm.

11. The system of claim 1, wherein one of the one or more communication devices is a smartphone, smartwatch, tablet, or remote controller.

12. The system of claim 1, wherein one of the one or more communication devices transmits the first identifier response signal upon receiving a user input corresponding to the first coordination identifier.

13. A method for identifying and determining a location of an individual, comprising:
identifying one or more individuals within a detection area based on a preliminary data set captured by one or more imaging sensors, wherein the detection area corresponds to fields of view of the one or more imaging sensors;
showing, via a display, a first coordination identifier;
receiving, by a controller, a first identifier response signal transmitted by one of one or more communication devices operated by one of the one or more individuals;
generating a first identifier time stamp corresponding to the controller receiving the first identifier response signal;
obtaining a first imaging data set captured by the one or more imaging sensors;
determining, based on the first imaging data set, a first head position pattern of the one or more individuals from a first pre-time stamp time to a first post-time stamp time;
identifying a first subset of the one or more individuals having a first head position pattern meeting a pre-determined head position pattern;
designating, if the first subset consists of only one individual, the individual of the first subset as a recognized individual; and
determining, based on the first imaging data set, the location of the recognized individual.

14. The method of claim 13, further comprising:
showing, via the display, a second coordination identifier;
receiving, via the controller, a second identifier response signal transmitted by one of the one or more communication devices operated by one of the one or more individuals;
generating a second identifier time stamp corresponding to the controller receiving the second identifier response signal;
obtaining a second imaging data set captured by the one or more imaging sensors;
determining, based on the second imaging data set, a second head position pattern of the individuals of the first subset from a second pre-time stamp time and a second post-time stamp time;
identifying a second subset of the individuals of the first subset having a second head position pattern meeting the pre-determined head position pattern;
designating, if the second subset consists of only one individual, the individual of the second subset as the recognized individual; and
determining, based on the second imaging data set, the location of the recognized individual.

15. The method of claim 13, further comprising transmitting, via one of the one or more communication devices, the identifier response signal upon receiving a user input corresponding to the coordination identifier.
